(19) United States
(12) Patent Application Publication
(10) Pub. No.: US 2003/0023431 A1
(43) Pub. Date: Jan. 30, 2003

(54) Method and system for augmenting grammars in distributed voice browsing

(76) Inventor: Marc Neuberger, Arlington, MA (US)

Correspondence Address: STAAS & HALSEY LLP, 700 11TH STREET, NW, SUITE 500, WASHINGTON, DC, 20001, US

(21) Appl. No.: 09/912,446

(22) Filed: Jul. 26, 2001

(51) Int. Cl. G10L 15/18

(52) U.S. Cl. 704/231

(57) ABSTRACT

When a caller requests access to a remote application server, a portal transfers an augmenting grammar set to the remote application server. The remote application server is connected to the caller and recognizes inputs by the caller. When an input is received which corresponds to the augmenting grammar set, the remote application server notifies the portal.

### BACKGROUND OF THE INVENTION

1. Field of the Invention

The present invention is directed to distributed voice browsing and, more particularly, to transferring an augmenting grammar set to a remote application server so that control of a call can be transferred from a communication carrier system or portal to the remote application server and, upon recognition of an input corresponding to the augmenting grammar set, the control over the call is transferred back to the communication carrier system.

2. Description of the Related Art

Voice controlled communications allows a person to simply pick up a telephone and conduct transactions such as banking transactions by speaking to an automated system without interacting with another person. As such speech-enabled applications become more common, the idea of a “voice portal” becomes increasingly appealing. A “voice portal” or“voice browser” is a site that a user can contact by phone, and through which the user can then gain access to a multitude of other speech-enabled applications. These applications may be developed and run by parties other than the voice portal. In essence, the portal serves as a gateway to various speech-enabled sites. The voice portal is often likened to the so-called “web portal” which serves as a central starting-point for users wishing access to a wide variety of applications, most of which are hosted by parties other than the web portal.

When a user requests a remote service, some form of control of the call is passed to the remote application. One approach is for the portal to begin taking instructions from the remote application. These instructions can be presented in some standard format such as VoiceXML. VoiceXML is a standardized language for specifying speech-enabled applications. With this approach, the portal continues to perform all speech recognition, audio prompt playing and other functions, but does so on behalf of the remote application. We will refer to this approach as the “distributed control” approach to voice browsing.

A second approach is for the portal to transfer the caller's speech to the remote application. In this approach, the remote application performs its own speech recognition. This benefits the portal by potentially requiring less resources from the portal site while the caller is interacting with the remote application. Although the remote application must now provide speech recognition resources, by doing so, it also gains greater control of the interaction with the caller. Transferring the caller's speech can be accomplished through a variety of mechanisms, including sending the speech over the internet (voice over IP), or actually transferring the call through the Public Switched Telephone Network (PSTN). We will refer to this approach as the “distributed speech” approach to voice browsing.

Although primarily aimed at speech-enabled applications, such voice portals could also take instruction from the caller via DTMF tones. Further, it is desirable that is be possible to develop remote applications that only use DTMF tones for user interaction rather than both speech and DTMF tones.

An example of the infrastructure which supports VoiceXML-based, “distributed-control” voice browsing is shown in FIG. 1. Referring to FIG. 1, a telephone 2 may be connected to a communication carrier 4, which acts as a voice portal. The communication carrier includes a platform 6 having a speech recognizer 8 and preferably further includes a VoiceXML interpreter 10. The speech which is transmitted from the telephone is recognized by the speech recognizer 8 and output to the VoiceXML interpreter 10. The VoiceXML interpreter 10 converts the speech into a signal which can be transmitted over the Internet 12 to a remote application server 14. Thereby, the caller can access the services of the remote application server 14 through the voice portal supplied by the communication carrier 4.

FIG. 2 presents an outline of how the second form of voice browsing, “distributed speech” browsing, where the actual voice signal is transferred to the remote application, might be implemented. Here, the caller uses telephone 2 to call into a hardware gateway 16 and is connected to the communication carrier 4 which acts as a voice portal. Thereafter, the caller may request a service which is provided by the application server 14. The communication carrier 4 recognizes the request and transmits any required state information along a control connection 20. This connection might be via a standard control protocol, such as a session initiation protocol (SIP). Next, the communication carrier 4 transmits the location of the application server 14, typically a URL, to the gateway 16 via connection 18. The gateway 16 then opens a connection 22 to the application server 14. Thereby, each input into the telephone 2 will be sent from the gateway 16 to both the communication carrier 4 and the application server 14.

According to the prior art, it is desirable for the communication carrier 4 to maintain some control over the call, even after control has been transferred to the application server 14 and the connection 22 has been established. This is useful because the communication carrier 4 may want to terminate the session with the application server 14, may need to act on the caller's behalf to send information to the application server 14 or may need to perform some other functions at the caller's request without terminating the session with the application server 14, for example.

However, to maintain some control over the call, it has been necessary in the prior art to have the communication carrier 4 listen to the conversation between the caller and the remote application server 14 and to perform speech recognition on all input utterances to determine when control should be transferred back to the communication carrier 4. Thereby, when the communication carrier 4 recognizes specific commands from the caller, it takes control of the call. Accordingly, the communication carrier 4 and the remote application server 14 both monitor the call and perform speech recognition on all input utterances. Thus, the communication carrier's speech recognition resources are used even when the caller is interacting with the remote application server 14.

Further, another drawback of this prior art method is that remote application server 14 will receive commands which are meant only for the communication carrier 4, which leads to unrecognitions or misrecognitions at the application server 14. Still further, input utterances which are sent to both the communication carrier 4 and the application server 14 can result in race conditions and the extra connections require additional bandwidth.

Thus, it is desirable for the communication carrier system to be able to disconnect the connection between itself and the caller, i.e., sever connection 18, while the caller is conducting a transaction with the application server 14.

It is also desirable to provide a system in which, when a certain word or phrase is uttered by the caller, the remote application server 14 recognizes the input utterance as one which should be handled by the communication carrier 4 and transfers control of the call back to the communication carrier system 4. Alternatively, commands may be input using standard DTMF tones. However, to accomplish this objective, it is necessary for the communication carrier 4 to augment the grammar set which is stored at the application server 14 to recognize certain such input utterances or tones.

### SUMMARY OF THE INVENTION

Accordingly, it is an object of the present invention to augment the speech recognition system of the remote application server system with an augmenting grammar set supplied from the communication carrier system.

It is a further object of the invention for the application server system to incorporate the transmitted augmenting grammar set into its recognition grammar set to form an augmented grammar set and, upon recognizing an input belonging to the augmenting grammar set, the application server system transfer control of the call back to a control system of communication carrier system.

A further object of the invention is to direct the communication carrier system to perform certain specified actions in response to an input from the caller which is recognized by the application server system as belonging to the augmenting grammar set.

A further object of the invention is to provide a method in which the communication carrier system is no longer required to perform speech recognition processing on every utterance from the call and, therefore, no telephony resources are required from the communication carrier system during this time.

These together with other objects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a diagram illustrating a distributed control voice browsing model according to the prior art;

FIG. 2 is a diagram illustrating the interconnections of a distributed speech voice browsing system according to the prior art;

FIG. 3 is a diagram illustrating a voice browsing model according to the present invention;

FIG. 4 is a flow chart showing a process of an embodiment of the present invention;

FIG. 5 is a flow chart showing a process of an embodiment of the present invention.

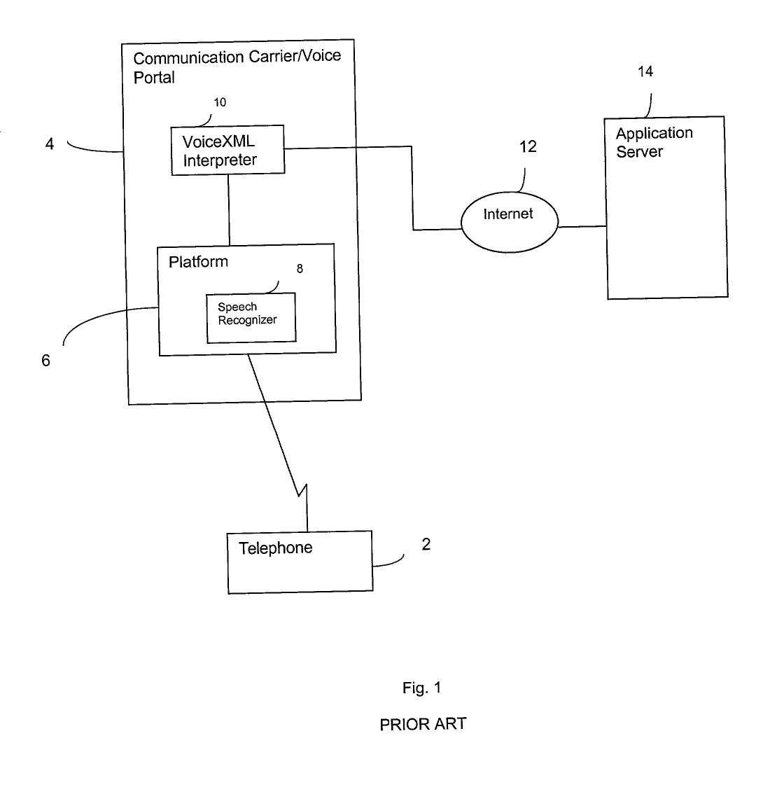

### DESCRIPTION OF THE PREFERRED EMBODIMENTS

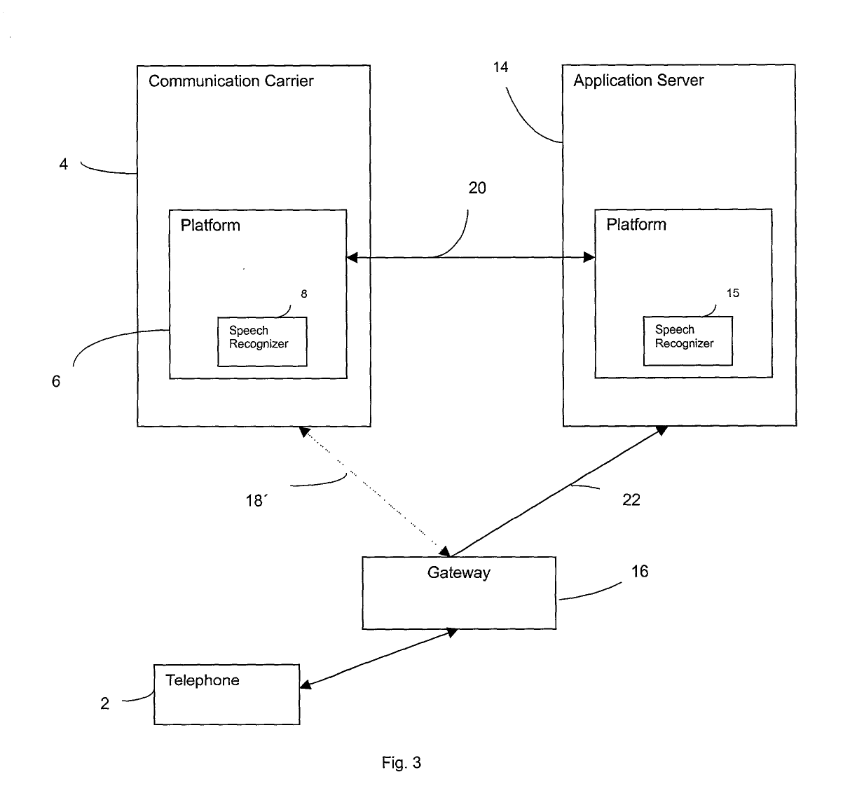

Referring to FIG. 3, according to the present invention, when a caller calls into the hardware gateway 16, the call is connected via connection 18′ to the communication carrier 4. As in the prior art method described previously, the caller may request services which can be provided by the application server 14. For example, the caller may request banking services from a particular bank. Next, the communication carrier transmits the required state information, together with an augmenting grammar set, to the application server 14 over control connection 20. The augmenting grammar set includes certain grammars which the communication carrier 4 is directing the application server 14 to recognize on its behalf. The augmenting grammar set is combined with the application server's recognition grammar set to form an augmented grammar set.

Both the communication carrier 4 and the application server 14 contain speech recognizers, 8 and 15 respectively. The speech recognizers 8, 15 are programmed to recognize sets of commands called grammars. The grammar specifies every possible combination of words which may be spoken by the user.

The process of augmenting grammars is known in the art and will be explained herein with reference to two grammar specification languages: jsgf (java speech grammar format) and GSL (Grammar Specification Language).

If the speech recognizer 15 uses jsgf and the communication carrier 4 has requested that the application server 14 recognize a jsgf grammar β. As an example, β might be “browser|telago|send my credit card number.” Next, assuming that the application server 14 recognizes a sequence of jsgf grammars {α₁, α₂, . . . , αₙ}. For example, αᵢ might be “checking|savings|four oh one kay.” To recognize the communication carrier's grammar, the application server 14 would use the|operator to “or” the communication carrier's grammar into each application server's grammar, giving the sequence {α₁|β, α₂|β, . . . , αₙ|β}. Using the example grammars, α₁|β would be “browser|telago | send my credit card number)|(checking|savings|four oh one kay.”

If the speech recognizer 15 uses GSL grammar [β]. As an example, β might be “(browser)(telago)(send my credit card number),” giving the GSL grammar [(browser)(telago) (send my credit card number)]. Assuming that the application server 14 recognizes a sequence of GSL grammars {[α₁], [α₂], . . . , [αₙ]}. For example, αᵢ might be “(checking)(savings)(four oh one kay).” To recognize the communication carrier's grammar the application server would use the juxtaposition operator to “or” the communication carrier's grammar into each application server's grammar, giving the sequence {[α₁β], [α₂β], . . . , [αₙβ]}. Using the example grammars, [αᵢβ] would be [(browser)(telago)(send my credit card number)(checking)(savings)(four oh one kay)].

Many speech recognizers provide some method of filling in parts of a grammar at run-time. The application can leave a slot for a run-time grammar, sometimes called a run-time non-terminal. An alternate implementation, using run-time non-terminals would be as follows: let “$b” be a run-time non-terminal. Now, rather than having the application server 14 recognize the sequence of grammars {α₁|β, α₂|β, . . . , αₙ|β}, we would recognize {α₁|$b, α₂|$b, . . . , αₙ|$b}. When the application begins, $b is set to equal β, thereby inserting the communication carrier's grammar without having to recompile all of the application grammars (α₁). Instead, the application server's grammar set is compiled once and for all, and then the communication carrier's grammar is compiled at the start of each application session and inserted into the run-time non-terminal reserved for it in the application server's grammar.

The operation of the voice browsing method is similar to the prior art except that once the connection 22 from the gateway 16 to the application server 14 is made, the connection 18′ between the gateway 16 and the communication carrier 4 is broken. Thus, while the caller is interacting with the application, no bandwidth is required between the gateway and the carrier, and no recognition resources are required at the carrier's site. Meanwhile, the connection 20 between the application server 14 and the communication carrier 4 is maintained.

In addition, since connection 18′ is broken during the time when control of the call resides with the application server 14, the resources of the speech recognizer 8 of the communication carrier 4 are freed until the remote application server 14 notifies the communication carrier 4 that it has recognized an utterance belonging to the augmenting grammar set which has been transmitted from the communication carrier 4 to the remote application server 14.

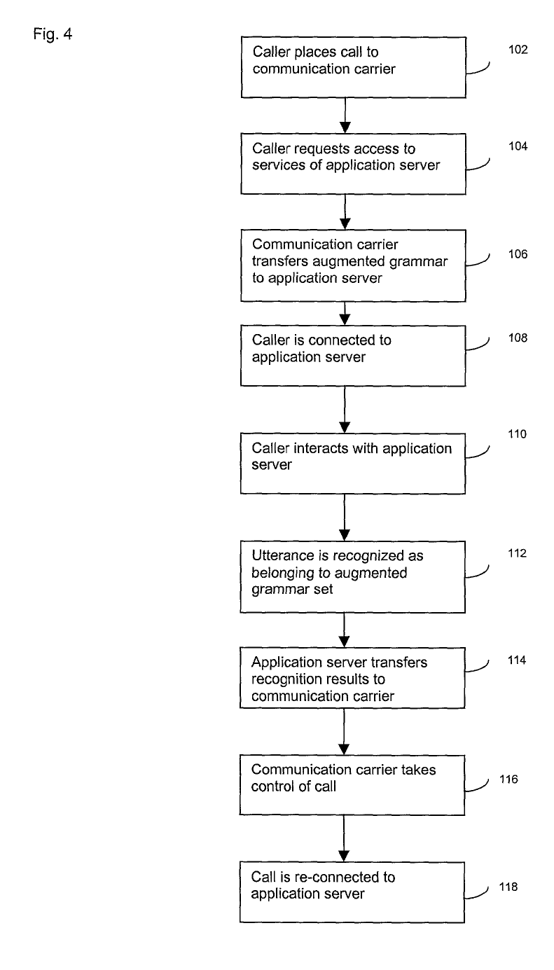

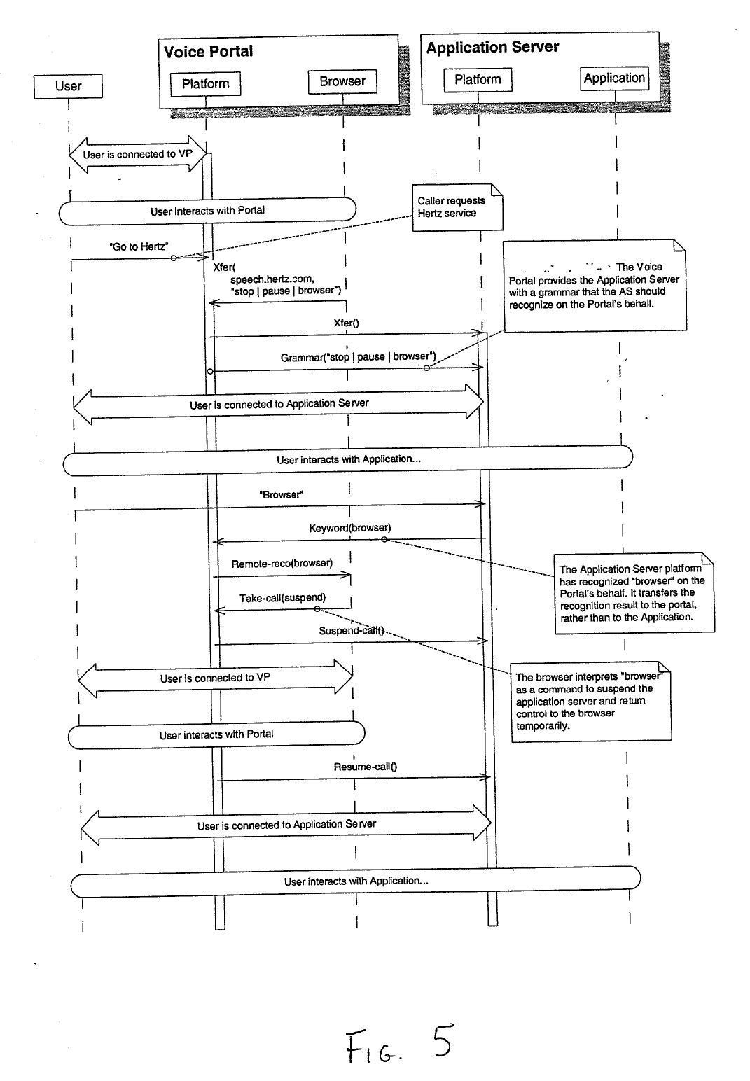

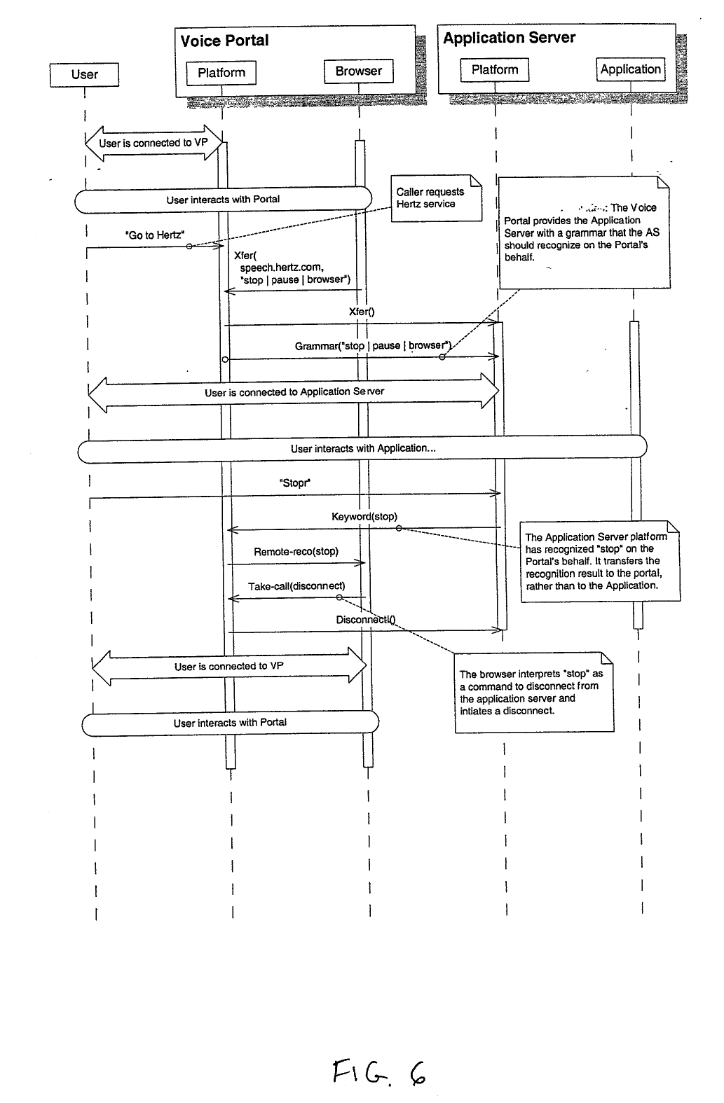

FIG. 4 is a flow chart showing a process according to the present invention. Referring to FIG. 3, in operation 102 a caller places a call to the communication carrier 4. At some point during the call, the caller requests access to an application which resides at a remote application server in operation 104. For example, during the user wishes to make reservations to rent a car at Hertz™. Thus, for example, the user utters the phrase “go to Hertz”. Then, in operation 106, the communication carrier transmits an augmenting grammar set to the remote application server 14.

In operation 108, the caller is connected to the remote application server, i.e., Hertz, and the caller conducts desired transactions with the remote application server system in operation 110. For example, the caller may make reservations to rent a car, etc. At this time, temporary control of the call is transferred to the remote application server system. In addition to recognizing the grammars necessary to conduct its business, the remote application server 14 is now capable of recognizing the augmenting grammars transmitted thereto by the communication carrier 4.

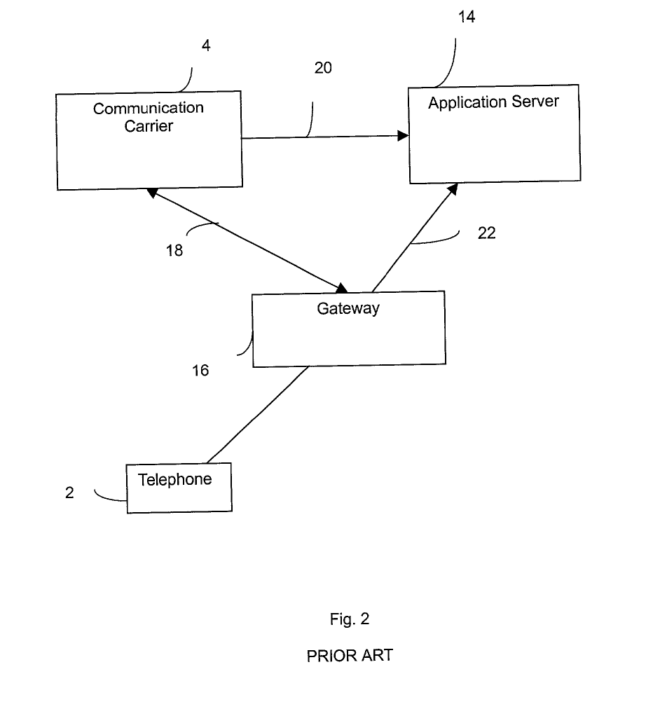

If at any time the caller utters a word or phrase belonging to the augmenting grammar set, this utterance is recognized by the remote application server 14 as belonging to the augmenting grammar set (operation 112). For example, if the user utters the phrase “browser”, the application server 14 recognizes this phrase as belonging to the augmenting grammar set and notifies the communication carrier 4 that this phrase has been uttered in operation 112. In operation 114, this utterance is transmitted to the communication carrier 4 to be recognized by the speech recognizer 8 of the communication carrier 4. Thus, according to the above example, the phrase “browser” is transmitted to the communication carrier 4 and recognized therein. The communication carrier 4 recognizes this as a command which requires the communication carrier 4 to take back control of the call from the remote application server system. In other words, to again establish connection 18 as shown in FIG. 2.

Thus, in operation 116, the communication carrier 4 takes control of the call. Depending on the command which is uttered by the caller, it is possible that the caller will again be connected to the remote application server 14 in operation 118 and control will be returned to the remote application server 14.

According to the invention, since the call is transferred to the remote application server 14, the communication carrier's speech recognition resources are made available to handle other callers. Further, since the grammar set of the remote application server 14 is augmented by the communication carrier 4, the grammar set of each system can be kept relatively small.

Beyond simply specifying grammars for the application to recognize on behalf of the communication carrier 4, according to the invention it is possible to have actions to be performed by the communication carrier 4 associated with each grammar element.

Specifically, one of a fixed, small set of actions can be associated with each grammar element. For example, this set may be {disconnect, hold/transfer, continue}. The communication carrier 4 could then specify, for each grammar element, whether the application should disconnect (terminate the session with the caller), hold/transfer (suspend state and allow the browser to interact with the caller), or continue (ignore the grammar and continue interacting with the caller). As an example, communication carrier 4 might specify the following annotated grammar: (terminate{disconnect}|telago{hold}). This would instruct the application to disconnect the caller and return control to the communication carrier 4 if the caller said “terminate”. If the user said “telago”, the application would temporarily return control to the communication carrier 4 so the caller could interact with the communication carrier 4 for some period of time, and then resume interaction with the remote application server 14.

It is also within the scope of the invention to allow somewhat more generality in the actions, for example, allowing the actions to take parameters. For example, a “transfer” action could be included. Thereby, the caller could specify a URL of an entirely different application, such as American Airlines™, in which to transfer the caller. Therefore, if the caller utters the phrase “American Airlines”, the caller would be transferred to the application server of American Airlines™, for example.

Finally, it is also within the scope of the invention to allow arbitrary actions to be executed on the communication carrier's behalf by the application server 14 when the caller says various things. For example, an arbitrary JavaScript would be allowed to be executed by the application server 14 for each grammar element. This gives potentially unlimited power to the communication carrier 4 in controlling the application server's behavior when the application was invoked through that communication carrier 4.

Although the embodiments of the present invention have been described herein with reference to voice based grammars, it should also be understood that it is within the scope of the present invention to augment DTMF grammars wherein both the communications carrier and the application server may be capable of recognizing DTMF or voice based inputs from the caller.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method of operating a speech recognition system, comprising:
augmenting the speech recognition system with an augmenting grammar set supplied by a portal; and
notifying the portal in response to an input which corresponds to the augmenting grammar set.

2. The method as claimed in claim 1, wherein the speech recognition system resides at an application server remote from the portal.

3. The method as claimed in claim 2, further comprising transferring control of a call back to the portal after notifying the portal that the input corresponds to the augmenting grammar set.

4. The method as claimed in claim 1, further comprising transferring a call to another application server which corresponds to the input.

5. The method as claimed in claim 2, further comprising directing the remote application server to perform one of a fixed set of pre-determined actions on behalf of the portal in response to a predetermined input.

6. The method as claimed in claim 2, further comprising directing the remote application server to perform an arbitrary routine on behalf of the portal in response to a predetermined input.

7. The method as claimed in claim 2, further comprising directing the portal to perform an action in response to a predetermined input.

8. A system comprising:
a portal; and
an application server having a speech recognizer to receive an augmenting grammar set transmitted from the portal, wherein the application server notifies the portal in response to an input which corresponds to the augmenting grammar set.

9. The system as claimed in claim 8, further comprising a voice gateway to connect a call to the portal.

10. The system as claimed in claim 9, wherein when a caller requests access to the application server, the voice gateway connects the call to the application server and breaks the connection between the call and the portal.

11. The system as claimed in claim 8, wherein the portal includes a speech recognizer.

12. The system as claimed in claim 11, wherein in response to an input being recognized as corresponding to the augmenting grammar set, control of the call is transferred from the application server to the portal.

13. The system as claimed in claim 8, wherein the call is transferred to another application server in response to recognizing a predetermined input as corresponding to the augmenting grammar set.

14. The system as claimed in claim 8, wherein the application server performs one of a fixed set of pre-determined actions on behalf of the portal in response to a predetermined input which is recognized as corresponding to the augmenting grammar set.

15. The system as claimed in claim 8, wherein the application server performs an arbitrary routine on behalf of the portal in response to a predetermined input which is recognized as corresponding to the augmenting grammar set.

16. The system as claimed in claim 8, wherein the portal performs a predetermined action corresponding to an input which is recognized as corresponding to the augmenting grammar set.

17. A method comprising:
connecting a call to a portal;
requesting services of a remote application server via the call;
transmitting an augmenting grammar set from the portal to the remote application server;
connecting the call to the remote application server;
breaking the connection between the call and the portal; and
notifying the portal when an input during the call corresponds to the augmenting grammar set.

18. The method as claimed in claim 17, further comprising reconnecting the call to the portal in response to recognizing a predetermined input as corresponding to the augmenting grammar set.

19. The method as claimed in claim 17, further comprising performing a predetermined action in response to an input which is recognized as belonging to the augmenting grammar set.

20. A system for operating a speech recognition system, comprising:
means for augmenting the speech recognition system with an augmenting grammar set supplied by a portal; and
means for notifying the portal in response to an input which corresponds to the augmenting grammar set.

21. The method as claimed in claim 1, wherein the input corresponds to at least one DTMF tone.

22. The method as claimed in claim 1, wherein the input corresponds to an spoken utterance.

23. The system as claimed in claim 8, wherein the input corresponds to at least one DTMF tone.

24. The system as claimed in claim 8, wherein the input corresponds to an spoken utterance.
